(19) United States
(12) Patent Application Publication
(10) Pub. No.: US 2005/0202387 A1
(43) Pub. Date: Sep. 15, 2005

(54) Book

(75) Inventors: Barrie Henderson, Woodbridge (GB); Simon Couchman, Woodbridge (GB); Piers Morgan, Amsterdam (NL)

Correspondence Address: BOURQUE & ASSOCIATES, P.A., 835 HANOVER STREET, SUITE 303, MANCHESTER, NH, 03104, US

(73) Assignees: Top That ! Publishing plc Marine House, Woodbridge (GB); Animal Magic BV, Amsterdam (NL)

(21) Appl. No.: 11/035,012

(22) Filed: Jan. 12, 2005

(30) Foreign Application Priority Data
Jan. 14, 2004 (GB) 0400747.2

(51) Int. Cl. G09B 5/00

(52) U.S. Cl. 434/317; 434/307 R

(57) ABSTRACT

A book (10) to be used with a counter (12). The book (10) has a main page (14) and a plurality of apertured pages (16) each containing an aperture (18). The book (10) has a movable magnet which is located upon a moveable component located within the main page (14). The counter (12) also contains a magnet, and the two magnets attract one another through the pages of the book. It is intended that children place the counter (12) on the first page of the book and then move it into the apertures (18) in the apertured pages (16) by manipulating the moveable component; the counter will then pass through the apertures (18) as the child turns the apertured pages (16) of the book (10).

### TECHNICAL FIELD

The invention relates to a book.

### BACKGROUND INFORMATION

Young children have short attention spans and often lose interest in storybooks fairly quickly. It is therefore beneficial to have a book with some added interest so that a child will remain interested in the book for longer, for example to improve their reading skills.

### SUMMARY

According to the invention, there is provided a book, said book comprising a plurality of apertured pages, a main page behind the apertured pages, a counter, a first magnetic means, a second magnetic means, wherein: the counter incorporates the first magnetic means; the second magnetic means is part of the main page of the book; the second magnetic means is movable within the main page; the apertured pages each have an aperture located at different positions on adjacent pages, the apertures are of a size such that the counter may pass through the apertures and the book is arranged such that, when the counter is attracted by the second magnetic means and the second magnetic means is moved, the counter is drawn across an apertured page into the aperture on that page.

The book preferably includes a front cover with at least some of the apertured pages being located between the front cover and the main page. The front cover may also include an aperture for the counter to pass through.

In this specification, reference is made to first and second magnetic means. At least one of these magnetic means will be a permanent magnet or will have a magnetic field induced by an applied electrical current. The other magnetic means may also be a permanent magnet (with the poles of the two being such that they are attracted to one another) or may be of a material which will be attracted to a permanent magnet.

The pages of the book may be hingedly connected to a first side of the main page. Alternatively, the book may have pages which fold out in different directions and are hinged on different sides of the main page. The main page will usually be at the back of the book but it may alternatively be located in the middle so that it has apertured pages on either side. In such an embodiment, the book may contain two stories so that a child may read the first story on one side of the main page and then turn the book over and read the second story. The book may also come with two or more counters, particularly in this embodiment where there may be a different counter for each story.

The second magnetic means may be attached to a movable component which can be used to move the second magnetic means relative to the plane of the main page. The movable component controls movement of the second magnetic means behind the apertured pages.

It is preferred that the movable component is a rotatable disc which rotates about a central axis such that the second magnetic means describes a circle when the rotatable disc is moved. This ensures that the second magnetic means follows a pre-determined path which will correspond to the locations of the apertures on the apertured pages so that when the second magnetic means is moved, the first magnetic means which is attracted to the second magnetic means is moved into the apertures in the apertured pages. The movable component may alternatively be a slide member or any other suitable means of moving the second magnetic means relative to the plane of the main page. There may also be more than one second magnetic means and more than one aperture in each apertured page.

The second magnetic means is preferably located at or adjacent a periphery of the rotatable disc so that the circular path described by the second magnetic means is as long as possible. However, the second magnetic means may be located anywhere on the disc.

It is preferred that the main page has a first and second layer and that the second magnetic means is located between the first and second layers as this allows concealment of the second magnetic means between the two layers. This arrangement also ensures that movement of the second magnetic means in a plane perpendicular to that of the main page is substantially prevented.

There may also be a spacer between the first and second layers, the spacer having a thickness such that it maintains a pre-determined distance between the first and second layer. The maintenance of a pre-determined distance between the two layers allows free movement of the second magnetic means between them. However, there may be no spacer between the two layers which may instead form an envelope.

The spacer may also be shaped so as to limit the movement of the second magnetic means in the plane of the main page. The spacer can guide the second magnetic means between the first and second layers to ensure that it follows a pre-determined path within the main page.

When the movable component is a rotatable disc, it can be located in a substantially cylindrical volume defined by the spacer, the first layer and the second layer. The advantage of the volume being substantially cylindrical is that it is complementary in shape to the disc. It is preferred that the disc is of a size such that it fits snugly in the substantially cylindrical volume. The disc is thereby retained within the substantially cylindrical volume and its movement in the plane of the page is substantially prevented. No further fixings are required. However, it should be understood that the rotatable disc may also be attached via a pivot located at its centre about which it can turn.

Optionally, part of either the first or second layer is cut away to expose a portion of a periphery of the rotatable disc. This facilitates access to the rotatable disc so that it may be turned more easily. It is preferred that all layers of the main page will be cut-away and that the cut-out portion/s will be semi-circular in shape. There may be one or more cut-away portions located on any side of the main page. However, it is preferred that there is only a single cut-out portion and that it will be located on a second side of the main page which is located opposite the first side of the main page. The apertured pages may also have cut-out portions to assist access to the rotatable disc located behind the apertured pages.

The rotatable disc may also have edge portions which are shaped so that the disc is easy to grip and turn. The edge portions may be serrated. Alternatively, the edge portions may be depressions in a surface of the rotatable disc or holes in the rotatable disc.

Although the attraction between the counter and the movable component has been described here as being a magnetic attraction, other mechanisms which can provide or generate similar attractive forces may also be possible, and the invention is not limited to magnetic attraction.

### BRIEF DESCRIPTION OF THE DRAWINGS

These and other features and advantages of the present invention will be better understood by reading the following detailed description, taken together with the drawings wherein:

FIG. 1 is The invention will now be further described, by way of example, with reference to the accompanying drawings, in which:

FIG. 1 is a representation of a book and a counter according to the invention;

FIG. 2 is a cross-sectional view of the main page of the book of FIG. 1;

FIG. 3 is a cross-sectional view of the main page of the book from the back showing a first embodiment of the rotatable disc;

FIG. 4 is a cross-sectional view of the main page of the book from the back showing a second embodiment of the rotatable disc; and

FIG. 5 is a cross-sectional of the main page of the book in an alternative embodiment of the invention.

### DETAILED DESCRIPTION OF THE PREFERRED EMBODIMENTS

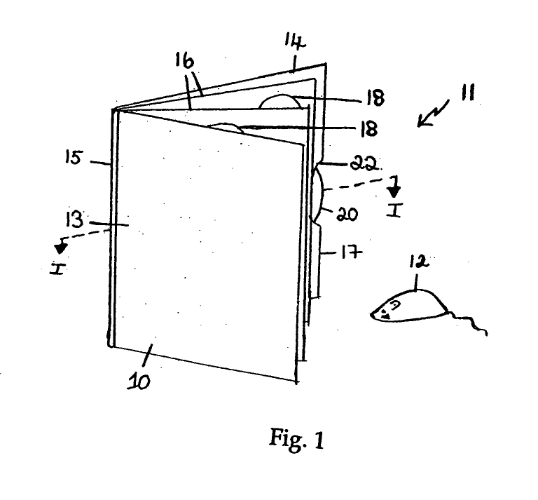

FIG. 1 shows a book 10 and a counter 12. In this embodiment, the counter 12 is a soft toy in the shape of a mouse. However, it should be understood that the counter may come in many different shapes and forms. For example, it may be a 2D counter made predominantly of cardboard or a plastics material. The counter 12 contains the first magnetic means (not shown) which is a magnet but which may also be any type of metal or ferromagnetic material that is attracted by or to magnets.

The book 10 has a front cover 13, a main page 14 and a plurality of apertured pages 16, the main page 14 being located at the back of the book. The apertured pages 16 each have an aperture 18 through which the counter 12 can pass and the main page 14 houses a rotatable disc 20. The apertured pages 16 are all hingedly connected to a spine on a first side 15 of the book 10. The rotatable disc 20 contains the second magnetic means 28. Again, the second magnetic means 28 is also a magnet however it could also be any type of metal or ferromagnetic material that is attracted by or to magnets. One of the first and second magnetic means will always be a magnet but they may both be magnets.

It is intended that a reader of the book place the counter 12 on a start position on a first apertured page. The start position will be indicated by the print on this first page. Once the reader has read the first page they must then turn the rotatable disc 20 containing the second magnetic means 28 which will attract the first magnetic means contained within the counter 12 thereby moving the counter 12 across the first apertured page until it reaches an aperture 18 in the page. The counter will drop into this aperture 18 and sit on a second apertured page until the first page is turned, at which point the counter will be free to move across the second apertured page. This process will then be repeated with each subsequent apertured page of the book 10. The number of apertured pages 16 in the book 10 may depend on the strength of the magnetic attraction which should be sufficient to ensure that the counter moves with the second magnetic means 28 whether the counter is on the first or last page of the book. It will not be necessary for the print on the apertured pages after the first to indicate a start position on the page, as this will be determined by the location of the apertures 18 on the preceding apertured pages. The positions of the apertures 18 on the apertured pages 16 will normally correspond to the circular path through which the second magnetic means 28 will pass as the rotatable disc 20 is turned. The apertures 18 on the apertured pages 16 may be holes in the middle of the pages 16 or cut-out portions at the edges of pages. The apertures 18 may be of any size or shape as long as the counter can pass though them but in this embodiment they are circular holes in the apertured pages 16.

The main page 14 also has a semi-circular cut-out portion 22 on a second side 17 of the main page 14 which is located opposite the first side 15 of the main page 14. The purpose of this semi-circular cut-out portion 22 is to allow the reader to grip and turn the rotatable disc 20.

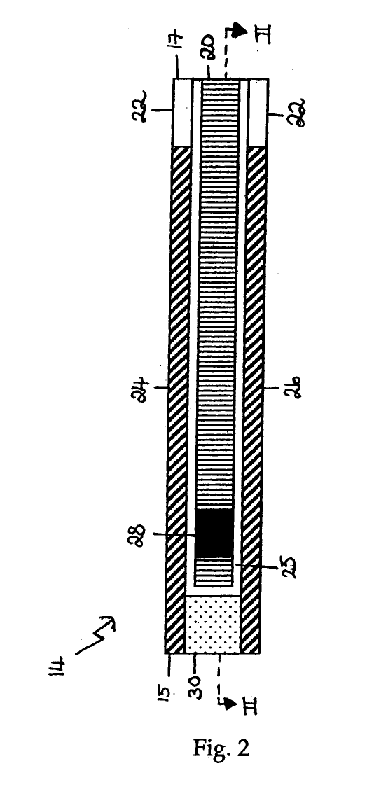

FIG. 2 is a cross-sectional view of the main page through the line I-I in FIG. 1. The main page 14 comprises two layers, a first layer 24 on the top and a second layer 26 on the bottom. A spacer 30 containing a substantially circular hole separates the first and second layers. Together the spacer 30, first layer 24 and second layer 26 define a substantially cylindrical volume 25 in which the rotatable disc 20 is located. The second magnetic means 28 is located in the rotatable disc 20 adjacent the first side 15 of the main page 14. There is a cut-out portion 22 on the second side 17 in both the first and second layers of the main page 14.

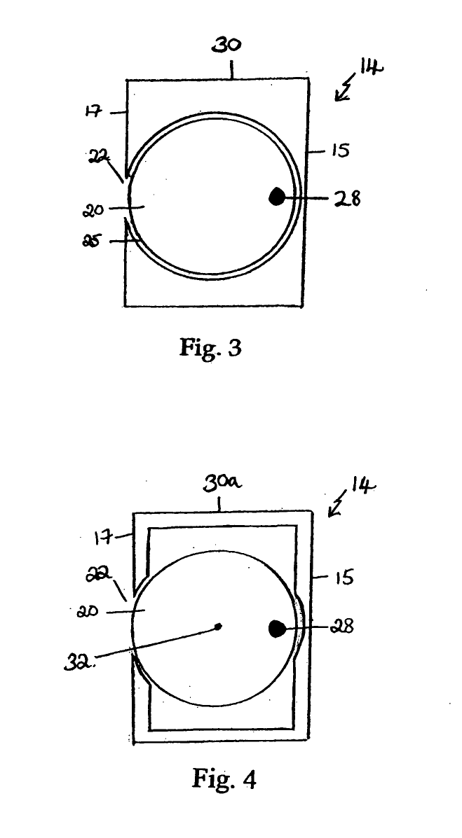

FIG. 3 shows a cross-sectional view of the main page of the book through the line II-II of FIG. 2 from a back surface. The spacer 30 extends around the periphery of the main page 14 and substantially encompasses the rotatable disc 20 in the substantially cylindrical volume 25. The spacer 30 does not extend around the disc 20 at a location corresponding to the cut-out portions 22 in the first and second layers of the main page 14. The rotatable disc 20 protrudes from the spacer 30 via the cut-out portions 22 so that it can be turned by a user. The second magnetic means 28 is located adjacent the periphery of the rotatable disc 20.

FIG. 4 shows a substantially identical view to that of FIG. 3 except the spacer 30 is located only at the periphery of the main page 14 and together with the first and second layers encloses a substantially cuboidal volume. The spacer 30 contacts the rotatable disc 20 at only three curved contact points and the rotatable disc 20 is attached to a pivot 32 at its central point. The first curved contact point is located at the first side 15 of the main page 14 near the spine of the book and the second and third points are located either side of the cut-out portion 22 on the second side 17. The three contact points act to locate the rotatable disc in the way as the spacer of FIGS. 2 and 3 and thereby relieve pressure on the pivot 32.

Although the embodiment described uses a rotatable disc to move the second magnetic means along a pre-determined path, there may be many other ways of achieving this. For example, as previously mentioned, the spacer layer may have a path that is circular or snake-like in form and the second magnetic means may be located at one end of a slide member.

In this case, the slide member will be located between the spacer and either the first or second layer of the main page and the second magnetic means will protrude from the slide member so that it fits into the path in the spacer layer. The second magnetic means will therefore pass along the pre-determined path defined by the spacer layer. The slide member will protrude out between the two layers of the main page of the book such that the slide member may be manipulated by the reader.

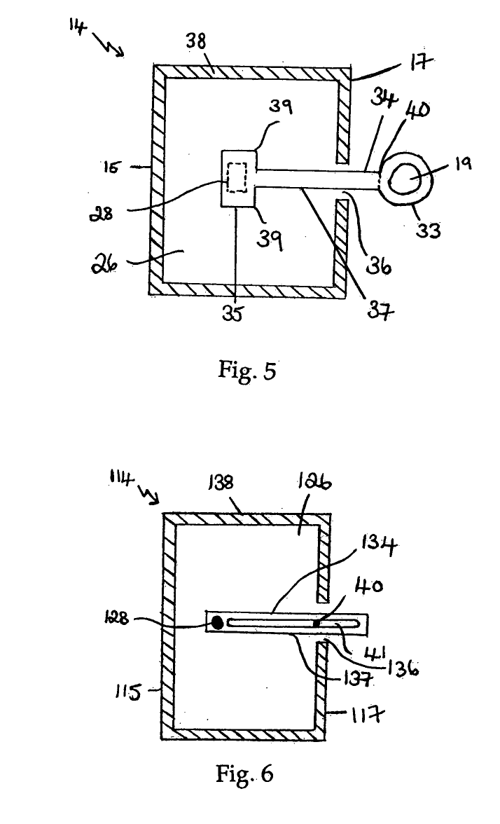

FIG. 5 shows a cross-section of the main page in an alternative embodiment of the invention in which the moveable component is a slide member 34. The slide member 34 is located between the first layer 24 (not shown) and the second layer 26 of the main page 14 of the book 11. In this embodiment, the two layers of the main page 14 are constructed from a larger piece of card or other suitable material which is folded in half and then glued around the edges (glue portions 38) to substantially form an envelope containing the slide member. A portion of each of the layers 24, 26 on the second side 17 of the main page 14 is not glued together. This creates a gap 36 between the layers so that at least part of the slide member 34 can protrude through the gap 36 and so that it can be manipulated by a user. Alternatively, there may be a spacer between the two layers 24, 26 located around the periphery of the main page 14 which spaces apart the layers and assists free movement of the slide member 34. This may be substantially in the same area as the glued portions 38.

The slide member 34 has a first end 33 which protrudes through the gap 36 between the layers 24, 26 of the main page 14 and is therefore located outside the body of the book 11, and a second end 35 which is located within the main page 14 between the first layer 24 (not shown) and the second layer 26. The slide member 34 further has a main body 37 between the first end 33 and the second end 35. The slide member 34 substantially comprises a flat elongate piece of sheet plastic or card or any other suitable material. The first end 33 of the slide member 34 is enlarged such that it is easier for a user to grasp and also has a hole 19 in the middle so that a user may place a finger through the hole 19 to further improve their grip on the slide member 34. The second end 35 of the slide member 34 includes the second magnetic means 28 and has shoulders 39 which are broader than the gap 36 in the main page 14. The shoulders 39 act as a stop to prevent the slide member 34 falling out of the main page 14. The slide member 34 further has a crease line 40 located between the main body 37 and the first end 33 of the slide member 34. During storage and transport of the book 11, the slide member 34 may be folded along this crease line 40 and the slide member 34 can be pushed into the main page 14 as far as it can go, so that the slide member 34 sits flush with the second side 17 of the main page 14 and does not protrude outwards where it might be damaged. Alternatively, the apertured pages 16 and the main page 14 may have cut-out portions (similar to those shown in FIG. 1, i.e. cut-out portions 22) that allow the slide member 34 to be pushed in far enough that it does not protrude outside the area of the book 11 but which also allow the user to grasp the slide member 34 and pull it out for use.

FIG. 6 shows an alternative embodiment of the slide member 34. The reference numerals for features having similar functions as those in FIG. 6 have been incremented by 100. The slide member 134 including the second magnetic means 128 is mounted on a pivot 40 which passes through an elongate slot 41 within the main body 137 of the slide member 134. This allows the slide member 134 and thus the second magnetic means 128 to be moved within the main page 114; freer movement of the second magnetic means 128 can be achieved than with the rotatable disc of FIGS. 1 to 4. The pivot 40 is preferably located adjacent the second side of the main page 114 and preferably in the region of the gap 136. In this embodiment, the slide member 134 has no shoulders as these are no longer required to retain the slide member 134 within the main page 114. This function is instead performed by the combination of the slot 41 and pivot 40. Again in this embodiment, the layers 124 (not shown) and 126 may be glued together at the glued portions 138 around the edges of the main page 114. Alternatively, there may be a spacer between the layers 124, 126.

The advantage of the book described is that, in combination with a counter which conforms to the story of the book, the entire reading experience will be enhanced. For example, if the book is about a lion then the counter may be in the form of a soft toy in the shape of a lion. This enhancement will lengthen the period that a young child can remain interested in the book and they will therefore learn more.

It is to be recognized that various alterations, modifications, and/or additions may be introduced into the constructions and arrangements of parts described above without departing from the spirit or scope of the present invention, as defined by the appended claims.

1. A book, said book comprising a plurality of apertured pages, a main page behind the apertured pages, a counter, a first magnetic means, a second magnetic means, wherein: the counter incorporates the first magnetic means; the second magnetic means is part of the main page of the book; the second magnetic means is movable within the main page; the apertured pages each have an aperture located at different positions on adjacent pages, the apertures are of a size such that the counter may pass through the apertures and the book is arranged such that, when the counter is attracted by the second magnetic means and the second magnetic means is moved, the counter is drawn across an apertured page into the aperture on that page.

2. A book as claimed in claim 1, wherein the main page of the book further has a first side and wherein all the apertured pages are hingedly connected to said first side of the main page.

3. A book as claimed in claim 1, wherein the book further comprises a moveable component and wherein the second magnetic means is attached to said movable component which can be used to move the second magnetic means within the main page.

4. A book as claimed in claim 3, wherein the movable component is a rotatable disc which rotates about a central axis such that the second magnetic means describes a circle when the rotatable disc is moved.

5. A book as claimed in claim 4, wherein the rotatable disc has a periphery and the second magnetic means is located at or adjacent said periphery of the rotatable disc.

6. A book as claimed in claim 1, wherein the main page has a first and second layer and the second magnetic means is located between the first and second layer.

7. A book as claimed in claim 6, wherein there is a spacer between the first and second layers comprising the main page, the spacer having a thickness such that it maintains a pre-determined distance between the first and second layer.

8. A book as claimed in claim 7, wherein the spacer acts as a guide for the second magnetic means.

9. A book as claimed in claim 7, wherein the moveable component is a rotatable disc and the spacer, the first layer and the second layer define a substantially cylindrical volume, and wherein the rotatable disc is located in said substantially cylindrical volume.

10. A book as claimed in claim 9, wherein part of either the first or second layer is cut away to expose a portion of a periphery of the rotatable disc.

11. A book as claimed in claim 4, the rotatable disc has grip-enhancing edge portions.

12. A book as claimed in claim 3, wherein the moveable component is a slide member, the slide member having a first and second end, and the main page of the book having a first and second layer, wherein the first end of the slide member extends from the main page such that a user may grasp it, and the second end of the slide member is located between the first and second layers of the main page, the second magnetic means being attached to the second end of the slide member such that manual manipulation of the first end of the slide member by a user results in movement of the second magnetic means within the main page.

13. A book as claimed in claim 12, wherein the main page and the slide member have means for preventing the second end of the slide member being withdrawn from between the layers of the main page such that the slide member is separated from the book.

14. A book, said book comprising a plurality of apertured pages, a main page behind the apertured pages, a counter, a first magnetic means, a second magnetic means, wherein: the counter incorporates the first magnetic means; the second magnetic means is part of the main page of the book; the second magnetic means is movable within the main page; the apertured pages each have an aperture located at different positions on adjacent pages, the apertures are of a size such that the counter may pass through the apertures and the book is arranged such that, when the counter is attracted by the second magnetic means and the second magnetic means is moved, the counter is drawn across an apertured page into the aperture on that page, and wherein the main page has a first and second layer and the second magnetic means is attached to a movable component which can be used to move the second magnetic means within the main page, the moveable component is located between the first and second layer of the main page and wherein the moveable component is a rotatable disc.

15. A book, said book comprising a plurality of apertured pages, a main page behind the apertured pages, a counter, a first magnetic means, a second magnetic means and a movable component wherein: the counter incorporates the first magnetic means; the second magnetic means is movable within the main page and is attached to the movable component; both the movable component and the second magnetic means form part of the main page of the book; the apertured pages each have an aperture located at different positions on adjacent pages, the apertures are of a size such that the counter may pass through the apertures and the book is arranged such that, when the counter is attracted by the second magnetic means and the second magnetic means is moved, the counter is drawn across an apertured page into the aperture on that page, wherein the main page has a first and second layer, the moveable component is located between said first and second layers of the main page and wherein the moveable component is a slide member.
